(19) United States
(12) Patent Application Publication
(10) Pub. No.: US 2015/0113641 A1
(43) Pub. Date: Apr. 23, 2015

(54) PLUG-IN ANTI-REGENERATION METHOD, SYSTEM, AND STORAGE MEDIUM

(71) Applicant: TENCENT TECHNOLOGY (SHENZHEN) COMPANY LIMITED, Shenzhen (CN)

(72) Inventor: Hongwei Zhang, Shenzhen (CN)

(73) Assignee: TENCENT TECHNOLOGY (SHENZHEN) COMPANY LIMITED, Shenzhen (CN)

(21) Appl. No.: 14/583,130

(22) Filed: Dec. 25, 2014

Related U.S. Application Data
(63) Continuation of application No. PCT/CN2013/076927, filed on Jun. 7, 2013.

(30) Foreign Application Priority Data
Jun. 28, 2012 (CN) 201210218212.8

(51) Int. Cl. G06F 21/56

(52) U.S. Cl. CPC G06F 21/56; G06F 2221/033
USPC 726/22

(57) ABSTRACT

The present invention provides a plug-in anti-regeneration method and system and a storage medium. The plug-in anti-regeneration method comprises: obtaining a plug-in anti-regeneration filter feature set; judging whether a to-be-installed plug-in matches plug-in anti-regeneration filter features in the plug-in anti-regeneration filter feature set; and preventing the to-be-installed plug-in from being installed if the to-be-installed plug-in matches the plug-in anti-regeneration features. The present invention further provides a corresponding plug-in anti-regeneration system. The method, system, and storage medium of the present invention can prevent the regeneration of the plug-in to facilitate the use of the computer.

### CROSS-REFERENCE TO RELATED APPLICATIONS

This present application is a Continuation Application of PCT application No. PCT/CN2013/076927, filed on Jun. 7, 2013, which claims priority to Chinese Patent Application No. 201210218212.8, entitled “Plug-in Anti-regeneration Method and System corresponding thereto”, filed by TENCENT TECHNOLOGY (SHENZHEN) COMPANY LIMITED on Jun. 28, 2012, the contents of which are hereby incorporated by reference.

### FIELD OF THE INVENTION

The present invention relates to computer technologies, and more particularly, to a plug-in anti-regeneration method and system and a storage medium.

### BACKGROUND OF THE INVENTION

Software is an important part of a computer. Functions of the computer can be realized by various kinds of software. For example, a browser is a kind of computer software configured to connect and communicate with the World Wide Web (WWW). The browser can determine the position of corresponding information resource according to a link in the WWW, extract the information resource in which a user may be interested, interpret a hypertext markup language (HTML) file, and restore character images or multimedia information.

In order to enhance or expand some software functions, various kinds of plug-ins have been developed to increase or decrease or expand functions of the corresponding software. A plug-in is a program which complies with certain application interface specifications and can be used by a main body of an application at random, thereby enhancing or expanding functions of the application. For example, after the browser installs various kinds of browser plug-ins, the browser can directly call the corresponding plug-in program, thereby expanding the function thereof. Therefore, the plug-ins can enhance the convenience of using the computer. Furthermore, a user is allowed to install some desired plug-ins on the computer to satisfy some particular requirements.

However, due to the flexibility and convenience of the plug-in, some malware has shown up at present. The malware is often installed on the computer against a user's will or without the user knowing it or by accident. In addition, it is hard to unload the malware. The malware greatly affects the use of the application program and causes undesired results including slowing running of the computer and damage of the application program, etc.

### SUMMARY OF THE INVENTION

In order to overcome the shortcomings of the present plug-in installing technology, an object of the present invention is to provide a plug-in anti-regeneration method and system for preventing the regeneration of the plug-in and further facilitating a user to use the computer.

The plug-in anti-regeneration method provided in an embodiment of the present invention includes:

obtaining a plug-in anti-regeneration filter feature set;

judging whether a to-be-installed plug-in matches plug-in anti-regeneration filter features in the plug-in anti-regeneration filter feature set; and

preventing the to-be-installed plug-in from being installed if the to-be-installed plug-in matches the plug-in anti-regeneration features.

The present invention further provides a plug-in anti-regeneration system, including an obtaining module configured to obtain a plug-in anti-regeneration filter feature set; a judging module configured to judge whether a to-be-installed plug-in matches plug-in anti-regeneration filter features in the plug-in anti-regeneration filter feature set; and a preventing module configured to prevent the to-be-installed plug-in from being installed if the to-be-installed plug-in matches the plug-in anti-regeneration filter features.

The present invention further provides a storage medium in which computer-executable instructions are stored, wherein the computer-executable instructions are configured to allow a computer to perform following operations:

obtaining a plug-in anti-regeneration filter feature set;

judging whether a to-be-installed plug-in matches plug-in anti-regeneration filter features in the plug-in anti-regeneration filter feature set; and

preventing the to-be-installed plug-in from being installed if the to-be-installed plug-in matches the plug-in anti-regeneration filter features.

The plug-in anti-regeneration method and system of the present invention generates the plug-in anti-regeneration filter feature set according to the user's daily behaviors, judges whether the to-be-installed plug-in matches the plug-in anti-regeneration filter features in the plug-in regeneration filter feature set when the plug-in is being installed; if yes, it indicates that the to-be-installed plug-in is the one previously removed by the user and thus the plug-in is prevented from being installed, which avoids the regeneration of the plug-in especially the malware and facilitates the use of the computer.

The above description is only a summary of the technical solutions of the present invention. In order to better understand the technical means of the present invention, to implement the present invention according to the content of the specification, and to make the above and other objects, features, and advantages of the present invention more easily understood, specific embodiments are described in detail below in connection with the accompanying drawings.

### BRIEF DESCRIPTION OF THE DRAWINGS

FIG. 1 is a flow chart of a plug-in anti-regeneration method in accordance with an embodiment of the present invention;

FIG. 2 is a detailed flowchart of a step S2 of the method of FIG. 1; and

FIG. 3 is a plug-in anti-regeneration system in accordance with an embodiment of the present invention.

### DETAILED DESCRIPTION OF THE INVENTION

In order to further illustrate technical means taken for achieving the intended purpose of the present invention and advantages of the technical means, embodiments, methods, steps, and advantages of a plug-in anti-regeneration method and system are described in more detail below with reference to the accompanying drawings and the preferred embodiments.

What's mentioned above and other technical solutions, features, and advantages of the present invention will become clearer in the specific description of the preferred embodiments combined with the accompanying drawings. By way of the embodiments, the technical means taken for achieving the intended purpose of the present invention and the advantages thereof can be understood in a more in-depth and detailed way, however, it will be appreciated that the accompanying drawings are only for reference and illustration and are not intended to limit the present invention.

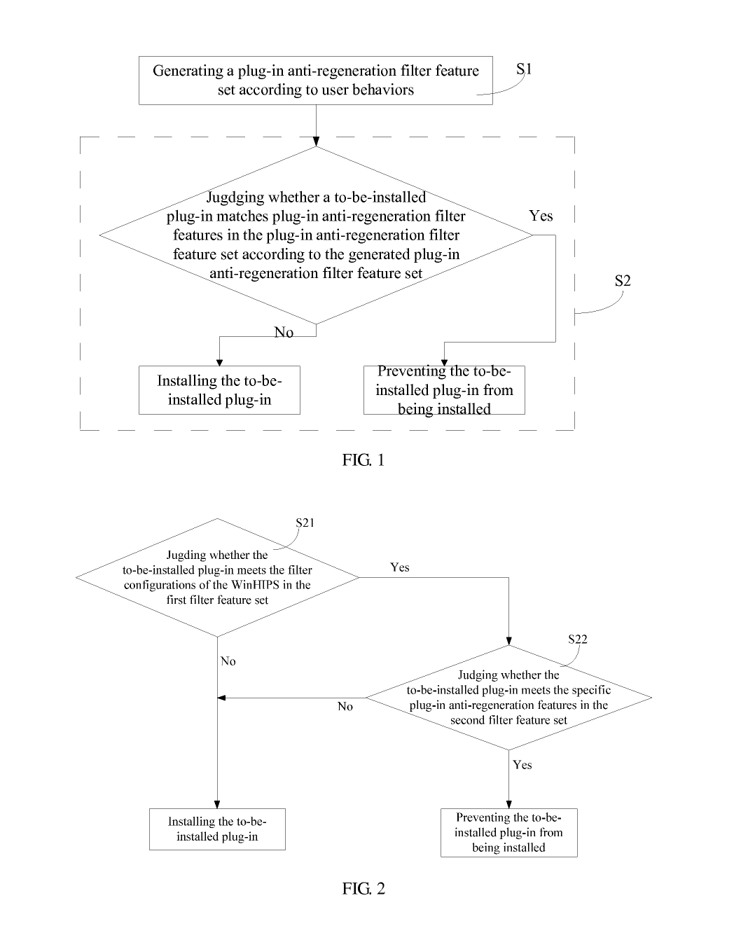

FIG. 1 is a flowchart of a plug-in anti-regeneration method in accordance with an embodiment of the present invention. As shown in FIG. 1, the method includes steps as follows.

Step S1, obtaining a plug-in anti-regeneration filter feature set.

The plug-in anti-regeneration filter feature set can be generated according to user behaviors including a user behavior of removing a plug-in. For example, a user uses a removing tool to remove the plug-in which is uncommonly used or undesired. In the process that the user removes the plug-in, the method of the present invention can extract features of the removed plug-in and set the features to be plug-in anti-regeneration filter features in the plug-in anti-regeneration filter feature set.

The plug-in anti-regeneration filter feature set includes a first filter feature set and a second filter feature set. The first filter feature set includes first filter features and the second filter feature set includes second filter features. In the present invention, the first filter features in the first filter feature set are filter configurations of a windows-NT-family host intrusion prevention system (WinHIPS), and the second filter features in the second filter feature set are other specific plug-in anti-regeneration features of the plug-in.

Therefore, the present invention can extract the features of the removed plug-in from a user's daily behavior of managing the plug-in, for example, the behavior of removing the plug-in, generate the simple and effective filter configurations of the WinHIPS and other specific plug-in anti-regeneration features of the plug-in, integrate the filter configurations of the WinHIPS into the first filter feature set, and integrate other specific plug-in anti-regeneration features of the plug-in into the second filter feature set.

A plug-in is a program complying with certain application interface specifications. Some plug-ins may be installed on the computer against a user's will or without the user knowing it or by accident when some applications are being used. For the user, the plug-ins are malware.

One having ordinary skill will appreciate that the plug-ins, particularly the malware, are installed under a certain install path or some particular install paths. Thus, the filter configurations of the WinHIPS in the first filter feature set can be set to correspond to a certain typical install path or some particular install paths of the plug-ins. However, these particular install paths may not only be the typical install paths of the plug-ins, but also be the typical install paths of other commonly-use applications. In this situation, the other specific plug-in anti-regeneration features in the second filter feature set are further used for corresponding to the plug-ins.

Step S2, judging whether a to-be-installed plug-in matches the plug-in anti-regeneration filter features in the plug-in anti-regeneration filter set; if yes, preventing the to-be-installed plug-in from being installed; otherwise, installing the to-be-installed plug-in.

When the plug-in is being installed, for example, when the user installs the plug-in intentionally or by accident or when some malware is installed automatically, the present invention automatically judges whether the to-be-installed plug-in matches the plug-in anti-regeneration filter features in the plug-in anti-regeneration feature set; if yes, it indicates that the to-be-installed plug-in is the one previously removed by the user and the to-be-installed is thus prevented from being installed, for example, a prompt box pops out to prompt the user to further judge whether the plug-in is required to be installed; otherwise, it indicates that the user did not remove the plug-in previously and the plug-in is continuously installed.

FIG. 2 shows details of the step S2. As shown in FIG. 2, based on that the plug-in anti-regeneration filter feature set includes the first filter feature set and the second filter feature set, and the plug-in anti-regeneration filter features include the filter configurations of the WinHIPS and other specific plug-in anti-regeneration features, the step S2 further includes steps as follows.

Step S21, judging whether the to-be-installed plug-in meets the filter configurations of the WinHIPS in the first filter feature set.

The present invention at first judges whether the to-be-installed plug-in meets the filter configurations of the WinHIPS in the first filter feature set, that is, whether the install path of the to-be-installed plug-in matches a typical or some particular install paths of the plug-ins. If not, it indicates that the plug-in is not the common malware and is allowed to be continuously installed. If yes, the following step S22 is performed.

Step S22, judging whether the to-be-installed plug-in matches the plug-in anti-regeneration features in the second filter feature set; if yes, preventing the to-be-installed plug-in from being installed.

When it is determined that the to-be-installed plug-in meets the filter configurations in the first filter feature set, it is required to further judge whether the to-be-installed plug-in matches the plug-in anti-regeneration features in the second filter feature set; if yes, it indicates that the to-be-installed plug-in is the one that was previously removed and the plug-in is prevented from being installed; otherwise, the plug-in is continuously installed.

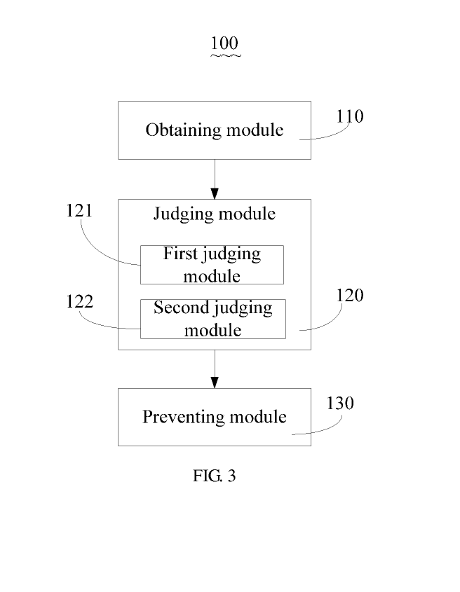

The present invention further provides a plug-in anti-regeneration system for implementing the method of the above embodiment. FIG. 3 shows the schematic view of the plug-in anti-regeneration system in accordance with an embodiment of the present invention. The system 100 includes an obtaining module 110, a judging module 120, and a preventing module 130. The obtaining module 110 is configured to obtain the plug-in anti-regeneration filter feature set. The judging module 120 is configured to judge whether the to-be-installed plug-in matches the plug-in anti-regeneration filter features in the plug-in anti-regeneration filter feature set. The preventing module 120 is configured to prevent the to-be-installed plug-in from being installed if the to-be-installed plug-in matches the plug-in anti-regeneration filter features in the plug-in anti-regeneration filter feature set.

The judging module 120, as defined, includes a first judging module 121 and a second judging module 122. The first judging module 121 is configured to judge whether the to-be-installed plug-in matches the filter configurations of the windows-NT-family host intrusion prevention system (WinHIPS) in the first filter feature set. The second judging module 122 is configured to judge whether the to-be-installed plug-in matches the specific plug-in anti-regeneration features in the second feature set. The preventing module 130 can be a prompt module configured to provide prompt information to prompt a user to further judge whether the to-be-installed plug-in needs to be installed.

The above modules are divided based on logic functions. In practical application, the function of each module can be realized by a plurality of modules or the functions of several modules can be realized by one module. In other embodiments, the plug-in anti-regeneration system can further include other modules. For example, the plug-in anti-regeneration system can include modules connected via internal buses such as the obtaining module, the judging module, the preventing module, a CPU, and a storage. The obtaining module, the judging module, and the preventing module respectively mainly start and control the functions thereof, while in practical applications, the functions of these modules can be cooperatively realized by other modules, for example, the processing function of the CPU may be utilized to read information from the storage and the internal buses can be utilized to transmit data, etc. The storage can be used to store software programs and modules, for example, for the program instructions/modules corresponding to the plug-in anti-regeneration method and system of the present invention, the CPU executes the software programs and modules stored in the storage, thereby implementing different kinds of function applications and data processing, that is, implementing the above plug-in anti-regeneration method.

As mentioned above, the plug-in anti-regeneration method and system of the present invention generates the plug-in anti-regeneration filter feature set according to the user's daily behaviors, judges whether the to-be-installed plug-in matches the plug-in anti-regeneration filter features in the plug-in regeneration filter feature set when the plug-in is being installed; if yes, it indicates that the to-be-installed plug-in is the one previously removed by the user and thus the plug-in is prevented from being installed, which avoids the regeneration of the plug-in especially the malware and facilitates the use of the computer.

The method and system provided in the present invention can be implemented by hardware or computer-readable instructions or combination of the hardware and computer-readable instructions. The computer-readable instructions can be stored in a readable storage medium such as a hard disc, a CD-ROM, a DVD, an optical disk, a floppy disc, a tape, a RAM, a ROM or any other suitable storage device by a plurality of processors. Alternatively, at least some computer-readable instructions can be replaced by specific hardware such as an application specific integrated circuit, a gate array, a FPGA, a PLD, and computers having specific functions.

The present invention provides the computer-readable storage medium for storing instructions allowing the computer to perform the above mentioned method. In detail, the system or device provided in the present invention has the storage medium in which computer-readable program codes are stored for realizing the functions of any above embodiment. Moreover, the system or device (CPU or MPU) can read and execute the program codes stored in the storage medium.

Based on this, any above embodiment can be implemented by reading the program codes from the storage medium, therefore, the program codes and the storage medium for storing the program codes form a part of the technical solution.

The storage medium used for storing the program codes includes but not limited to a floppy disc, a hard disc, a magneto optical disc, an optical disc (such as CD-ROM, CD-R, CD-RW, DVD-ROM, DVD-RAM, DVD-RW, DVD+RW), a tape, a flash memory card, a ROM, etc. Alternatively, the program codes can be downloaded from a server through communication networks.

It is noted that, for the program codes executed by the computer, at least a part of the operation which is implemented by the program codes can be implemented by an operating system of the computer which executes instructions based on the program codes, thereby realizing the technical solution of any above embodiment.

In addition, the program codes in the storage medium are written into the storage which can be located in an expansion board of the computer or an expansion unit connected to the computer. In the embodiment, the CPU performs at least a part of the operation based on the program codes in the expansion board and the expansion unit, thereby realizing the technical solution of any above embodiment.

What is claimed is:

1. A plug-in anti-regeneration method, comprising:
obtaining a plug-in anti-regeneration filter feature set;
judging whether a to-be-installed plug-in matches plug-in anti-regeneration filter features in the plug-in anti-regeneration filter feature set; and
preventing the to-be-installed plug-in from being installed if the to-be-installed plug-in matches the plug-in anti-regeneration features.

2. The method of claim 1, further comprising:
installing the to-be-installed plug-in if the to-be-installed plug-in does not match the plug-in anti-regeneration filter features.

3. The method of claim 1, wherein the plug-in anti-regeneration feature set comprises a first filter feature set and a second filter feature set, the first filter feature set comprises first filter features, and the second filter feature set comprises second filter features.

4. The method of claim 3, wherein the first filter features are filter configurations of a windows-NT-family host intrusion prevention system, and the second filter features are specific plug-in anti-regeneration features.

5. The method of claim 4, wherein judging whether a to-be-installed plug-in matches plug-in anti-regeneration features in the plug-in anti-regeneration filter feature set comprises:
further judging whether the to-be-installed plug-in matches the specific plug-in anti-regeneration features in the second filter feature set if the to-be-installed plug-in matches the plug-in anti-regeneration filter features; and
preventing the to-be-installed plug-in from being installed if the to-be-installed plug-in matches the specific plug-in anti-regeneration features.

6. The method of claim 1, further comprising: generating the plug-in anti-regeneration filter feature set according to user behaviors.

7. The method of claim 6, wherein the user behaviors comprise a user behavior of removing a plug-in.

8. The method of claim 7, wherein generating the plug-in anti-regeneration filter feature set according to user behaviors comprises:
in the process of removing the plug-in, further extracting features of the removed plug-in and setting the features of the removed plug-in to be the plug-in anti-regeneration filter features in the plug-in anti-regeneration filter feature set.

9. The method of claim 1, wherein preventing the to-be-installed plug-in from being installed comprises:
prompting a user to further judge whether the to-be-installed plug-in needs to be installed.

10. A plug-in anti-regeneration system, comprising:
an obtaining module configured to obtain a plug-in anti-regeneration filter feature set;
a judging module configured to judge whether a to-be-installed plug-in matches plug-in anti-regeneration filter features in the plug-in anti-regeneration filter feature set; and
a preventing module configured to prevent the to-be-installed plug-in from being installed if the to-be-installed plug-in matches the plug-in anti-regeneration filter features.

11. The system of claim 10, wherein the plug-in anti-regeneration filter feature set comprises a first filter set and a second filter set, the first filter set comprises first filter features, and the second filter set comprises second filter features.

12. The system of claim 11, wherein the first filter features are filter configurations of a windows-NT-family host intrusion prevention system, and the second filter features are specific plug-in anti-regeneration features.

13. The system of claim 12, wherein the judging module comprises:
a first judging module configured to judge whether the to-be-installed plug-in matches the filter configurations of the windows-NT-family host intrusion prevention system; and
a second judging module configured to further judge whether the to-be-installed plug-in matches the specific plug-in anti-regeneration features in the second filter feature set.

14. The system of claim 10, wherein the obtaining module obtains the plug-in anti-regeneration filter feature set according to user behaviors.

15. The system of claim 14, wherein the user behaviors comprise a user behavior of removing a plug-in.

16. The system of claim 10, wherein the preventing module is a prompt module configured to provide prompt information to prompt a user to judge whether the to-be-installed plug-in needs to be installed.

17. A storage medium in which computer-executable instructions are stored, wherein the computer-executable instructions are configured to allow a computer to perform following operations:
obtaining a plug-in anti-regeneration filter feature set;
judging whether a to-be-installed plug-in matches plug-in anti-regeneration filter features in the plug-in anti-regeneration filter feature set; and
preventing the to-be-installed plug-in from being installed if the to-be-installed plug-in matches the plug-in anti-regeneration filter features.

18. The storage medium of claim 17, wherein the to-be-installed plug-in is installed if the to-be-installed plug-in does not match the plug-in anti-regeneration filter features.

19. The storage medium of claim 17, wherein the plug-in anti-regeneration filter feature set comprises a first filter set and a second filter set, the first filter set comprises first filter features, and the second filter set comprises second filter features.

20. The storage medium of claim 19, wherein the first filter features are filter configurations of a windows-NT-family host intrusion prevention system, and the second filter features are specific plug-in anti-regeneration features.
